(19) United States
(12) Patent Application Publication
(10) Pub. No.: US 2023/0334538 A1
(43) Pub. Date: Oct. 19, 2023

(54) ELECTRONIC COMMERCE MANAGEMENT COMPUTER FOR PROVIDING PRODUCT INFORMATION, PRODUCT INFORMATION MANAGEMENT COMPUTER, AND PRODUCT INFORMATION PROVISION METHOD

(71) Applicant: Seong Min YOON, Guri-si (KR)

(72) Inventor: Seong Min YOON, Guri-si (KR)

(21) Appl. No.: 18/027,806

(22) PCT Filed: Sep. 16, 2021
(86) PCT No.: PCT/KR2021/012739

§ 371 Date: Mar. 22, 2023

(30) Foreign Application Priority Data
Sep. 24, 2020 (KR) 10-2020-0123855

(51) Int. Cl. G06Q 30/0282

(52) U.S. Cl. CPC G06Q 30/0282

(57) ABSTRACT

-- The present invention relates to an electronic commerce management computer for providing product information, a product information management computer, and a product information provision method. An electronic commerce management computer having electronic commerce means includes at least one hardware processor, and a memory storing program, wherein the at least one hardware processor controls the execution of the program stored in the memory to receive product information content relating to a product generated by participants, to extract information of a non-related person who is not related to the product from the participants, and to register the product information content entered by the non-related person to the electronic commerce means. --

### BACKGROUND OF THE INVENTION

### 1. Field of the Invention

The present invention relates to an electronic commerce management computer for providing product information, a product information management computer, and a method for providing product information. More specifically, the present invention relates to the provision of product information in electronic commerce, in which products are sold and products are purchased in an online shopping mall or the like, in which evaluations and testimonials about the products by a purchaser of the products or a person who has been provided with the products are registered to provide information about the products to general consumers to make a purchase decision. The present invention identifies product information providers as non-related persons, such as non-related persons who are not related to the seller, except for the seller of the products and the seller’s related persons, including the seller’s acquaintances, non-related persons who are not related to the producer, except for the producer of the products and the producer’s related persons, including the producer’s acquaintances, and non-related persons who are not related to the competitor, except for competitors who are in competition with the seller and producer of the products and related persons of the competitor, including the competitor’s acquaintances. The evaluation of the product is guaranteed to be objective by providing consumers with the rating or review content of the product presented by the non-related persons of the present invention.

### 2. Description of Related Art

When a consumer decides to purchase a product, prior information about the product plays a crucial role in the consumer’s purchase decision. To this end, producers and sellers of products have traditionally invested a lot of money and time in advertising and promoting their products. In particular, in non-face-to-face commerce such as online shopping malls, it is not possible to see or experience the actual product, which limits the ability of sellers and producers to effectively communicate product information to consumers. In recent years, marketing methods have been actively used by product and producer companies to deliver indirect experience information to consumers to help them make purchase decisions. One of the most popular methods is through product reviews, where product buyers or product users post their opinions about the product online. However, since product reviews are used by sellers and producers as a means of promoting products, it is difficult to ensure the objectivity of the product information, such as providing positive reviews to consumers, so consumers who encounter product information through product reviews may not trust the product information.

As an invention to solve these prior art problems, the invention of a product trading system and its method is disclosed in Korean Public Patent No. 10-2016-0129384 (publication date: Nov. 9, 2016).

The product trading method of the disclosed invention includes: preparing, by a seller computer, an online website, wherein a seller terminal registers product information including seller information, product information, and advance profit or advance compensation information related to the products entered or set by the seller of an offline store, and user member information to trade the product, and seller content including the type and extent of user content to be provided by the user member in exchange for trading the products, with a seller computer; registering, by at least one user terminal, by a connected seller computer by entering user information, product review history, and user information regarding the operated website, social networking service (SNS), blog, etc. into a member registration means provided; registering, by the seller computer, as a user member based on user information transmitted from the at least one user terminal, and generating and storing a digital identification certificate that categories the user members by level; accessing by, the at least one user terminal, a website provided by the seller computer and selecting a product by consulting the seller content related to the product offered by the seller and submitting a transaction request to the seller computer; receiving, by the seller computer, the transaction request from the at least one user terminal and determining that the digital identification certificate information of the user member of the at least one user terminal and the transaction terms of the seller content of the requested product match; approving, by the seller computer, the product transaction request of the at least one user terminal and storing the product transaction request in association with the user member information if the user member’s digital identification information and the transaction terms of the requested product match; outputting, by the at least one user terminal, the digital identification certificate of the user member at the offline store; receiving, by the seller terminal, a query request inputted by seller of the offline store based on information on the digital identification certificate outputted to the at least one user terminal, and outputting products trading approval information; outputting, by the merchant terminal, the products transaction approval information in response to receiving an inquiry request for approval of the products transaction entered by a seller of the offline store based on the digital identification certificate information output to the at least one user terminal; and generating, by the at least one user terminal that has traded the product in exchange for an advance profit or advance compensation offered by the seller, user content of the type that the seller specified as a condition of transaction, and registering the user content to the seller computer or at least external internet medium.

The disclosed invention issues digital identification certificates authenticated by the seller to members based on the information of buyers registered as members on the seller computer, and allows only members with the digital identification certificates to register content such as reviews and testimonials regarding the seller’s products. There is a problem with the structure of issuing digital identification certificates to members who are authenticated by the seller, which means that members with digital identification certificates can only provide positive reviews or testimonials about the seller’s products.

In addition, the invention of a review reliability verification service provision system using networking information and its provision method has been registered under Korean Registered Patent No. 10-1279713 (registration date: Jun. 21, 2013).

The patented invention includes: a review extraction step in which a valid review extraction server, which receives business information transmitted by a user in a communication network using a user terminal to search for reviews and information of a service or product to be purchased, extracts reviews of the service or product from a review database; a bad reviewer filtering step in which a bad reviewer filtering unit provided in the valid review extraction server extracts valid reviews by removing reviews registered by bad reviewers from the reviews extracted from the review database, and derives a valid review satisfaction rating from the satisfaction ratings assigned to the valid reviews in a valid review satisfaction calculation unit provided in the valid review extraction server and transmits the valid review satisfaction rating to the user terminal; and a valid review reliability verification step in which the valid review reliability verification server calculates a relation rating from the ratings registered by the reviewers in the relation information that the user has registered in advance and stored in the relation database among the valid reviews, compares the valid review satisfaction with the relation rating to determine the reliability of the valid review satisfaction, and transmits the relation rating to the user terminal for display.

The patented invention is an invention that extracts valid reviews by removing reviews by bad reviewers from the accumulated review database, and verifies valid reviews based on the rating information registered by reviewers in the user’s network based on the network database registered by the user to ensure the reliability of reviews using network information.

However, although the patented invention consists of filtering reviews of bad reviewers from a review database and providing reliable review information to a user based on the ratings of reviewers in the user’s network information, there is a problem that it is difficult to secure reliability because it is not possible to specify the bad reviewer information to be filtered and the relationship of the reviewer in the network information to the seller or producer.

### SUMMARY OF THE INVENTION

In order to solve the problems of the prior art, the purpose of the present invention is to provide an electronic commerce management computer, a product information management computer, and a product information provision method for providing product information that excludes product information registered by related persons, including a seller, a producer, an acquaintance of a seller and a competitor of a producer, from product information including reviews or testimonials of products registered or being registered in electronic commerce, and provides product information registered or being registered by non-related persons not related to the seller, producer, and competitor of the seller and producer to a consumer.

As a technical solution to achieve the object of the present invention, in a first aspect of the present invention, there is provided an electronic commerce management computer including electronic commerce means, at least one hardware processor, and a memory storing program, wherein the at least one hardware processor controls the execution of the program stored in the memory: receiving product information content relating to a product generated by participants; extracting information of a non-related person who is not related to the product from the participants; and registering the product information content entered by the non-related person to the electronic commerce means.

In a second aspect of the present invention, an electronic commerce management computer includes electronic commerce means, at least one hardware processor, and a memory storing program, wherein the at least one hardware processor controls the execution of the program stored in the memory: receiving product information content relating to a product generated by participants; extracting information of a non-related person who is not related to the product from the participants; providing the product information content to the non-related person and requesting an evaluation of the product information content; and registering the product information content conforming to the criteria set based on the evaluation information of the product information content provided by the non-related person, to the electronic commerce means.

Further, in a third aspect of the invention, a product information management computer in communication with at least one electronic commerce management computer managing electronic commerce means and including at least one hardware processor and a memory storing a program, wherein the at least one hardware processor controls execution of the program stored in the memory: receiving product information content concerning products generated by participants and registered in a particular electronic commerce means; extracting information of non-related person who is not related to the product among the participants, registering the product information content entered by the non-related person to the particular electronic commerce means.

Further, in a fourth aspect of the invention, a product information management computer in communication with at least one electronic commerce management computer managing electronic commerce means and including at least one hardware processor and a memory storing a program, wherein the at least one hardware processor controls execution of the program stored in the memory: receiving product information content concerning products generated by participants and registered in a particular electronic commerce means; extracting information of non-related person who is not related to the product among the participants; providing the product information content to the non-related person and requesting an evaluation of the product information content; and registering the product information content conforming to the criteria set based on the evaluation information of the product information content provided by the non-related person, to the electronic commerce means.

In a fifth aspect of the present invention, a product information provision method using an electronic commerce management computer that manages electronic commerce means, includes: receiving, by the electronic commerce management computer, product information content relating to a product generated by participants; extracting, by the electronic commerce management computer, information of a non-related person who is not related to the product from the participants; and registering, by the electronic commerce management computer, the product information content entered by the non-related person to the electronic commerce means.

Also, in a sixth aspect of the present invention, a product information provision method using an electronic commerce management computer that manages electronic commerce means, includes: receiving, by the electronic commerce management computer, product information content relating to a product generated by participants; extracting, by the electronic commerce management computer, information of a non-related person who is not related to the product from the participants; providing, by the electronic commerce management computer, the product information content to the non-related person and requesting an evaluation of the product information content; and registering, by the electronic commerce management computer, the product information content conforming to the criteria set based on the evaluation information of the product information content provided by the non-related person, to the electronic commerce means.

In a seventh aspect of the present invention, a product information provision method using a product information management computer in communication with at least one electronic commerce management computer managing the electronic commerce means, includes: receiving, by the product information management computer, product information content relating to a product registered in a particular electronic commerce means generated by participants; extracting, by the product information management computer, information of a non-related person who is not related to the product from the participants; and registering, by the product information management computer, the product information content entered by the non-related person to the electronic commerce means.

In an eighth aspect of the invention, a product information provision method using a product information management computer in communication with at least one electronic commerce management computer managing the electronic commerce means, includes: receiving, by the product information management computer, product information content relating to a product registered in a particular electronic commerce means generated by participants; extracting, by the product information management computer, information of a non-related person who is not related to the product from the participants; providing, by the product information management computer, the product information content to the non-related person and requesting an evaluation of the product information content; and registering, by the product information management computer, the product information content conforming to the criteria set based on the evaluation information of the product information content provided by the non-related person, to the electronic commerce means.

### Advantageous Effects of the Invention

According to the present invention, when providing consumers with ratings and reviews of products transacted in an electronic commerce system such as an online shopping mall, it is possible to provide consumers with product information that includes ratings and reviews of products with guaranteed objectivity by providing only product information content generated by non-related persons related to the product, excluding product ratings and reviews generated by the seller of the product, related-persons of the seller, the producer, related-persons of the producer, the competitors of the seller and producer, and related-persons of the competitors.

### BRIEF DESCRIPTION OF THE DRAWINGS

FIG. 1 is a schematic configuration of an embodiment of the product information provision system of the present invention.

FIG. 2 is a schematic configuration of an embodiment of an electronic commerce management computer, which is the main part of the product information provision system of the present invention.

FIG. 3 is a schematic diagram of an embodiment of a relationship information management module, which is the main part of the electronic commerce management computer of the present invention.

FIG. 4 is a schematic diagram of another embodiment of the product information provision system of the present invention.

FIG. 5 is a schematic flow diagram to illustrate an embodiment of the product information provision method of the present invention.

FIG. 6 is a schematic flow diagram to illustrate another embodiment of the product information provision method of the present invention.

FIG. 7 is a schematic flow diagram to illustrate another embodiment of the product information provision method of the present invention.

FIG. 8 is a schematic flow diagram to illustrate another embodiment of the product information provision method of the present invention.

### BEST EMBODIMENT FOR IMPLEMENTING THE INVENTION

As the best form for implementing the present invention, an invention is presented that can secure objectivity of product information including reviews and testimonials by providing product information generated by non-related persons other than the seller and producer, related persons including acquaintances of the seller and producer, competitors of the seller and producer, and related persons including acquaintances of the competitors, in providing product information including reviews and testimonials to the consumers in electronic commerce including sellers, producers, users, buyers, and consumers of products.

### EXEMPLARY EMBODIMENTS FOR IMPLEMENTING THE INVENTION

Hereinafter, an embodiment of the product information provision system and method of the present invention will be described in detail with reference to the accompanying drawings.

Terms used in the description of the embodiments of the present invention will be defined. The various computers and terminals used in the present invention may be configurations of hardware itself, or configurations of computer programs and web programs that utilize the hardware resources. For example, the electronic commerce management computer, the commerce management computer, and the product information management computer of the present invention may be configurations of hardware included in the respective computers, and each component of the web program or computer program stored in the storage means of the respective computers may be configured to be executed by utilizing the hardware resources of the central processing unit (CPU), including instructions and algorithms stored in the registers of the computer.

Also, in the description of embodiments of the present invention, terms such as “part,” “module,” “means,” or “unit” are used or may be used interchangeably for the same configuration and may be used interchangeably as appropriate depending on the action of the component. The terms may refer to hardware configurations of computers or terminals, and to respective components of web programs or computer programs stored in storage means of computers and terminals and executed under the control of a central processing unit (CPU) or processor.

In embodiments of the present invention, the terms are primarily used to refer to each component of the web program or computer program.

It is understood that any other term or expression not defined herein is not intended to be limited to that term or expression, but may have a greater meaning in the action or function of the component represented.

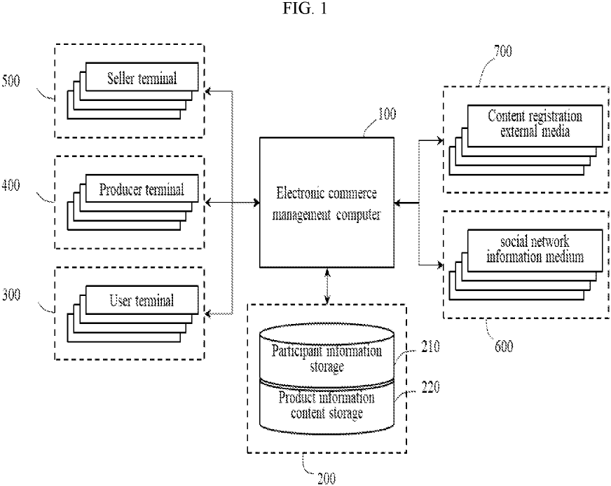

FIG. 1 is a schematic configuration of an embodiment of a product information delivery system of the present invention.

As illustrated in FIG. 1, the product information provision system of the present invention comprises an electronic commerce management computer 100 equipped with an online electronic commerce means for selling and trading products and managing product information including information of sellers and related persons, information of producers and related persons, information of competitors and related persons of the sellers and producers, and product information including ratings of products registered or to be registered by users and reviews of product use; a data storage computer 200 comprising a participant information storage 210 that stores and manages participant information including user members, seller members, and producer members who are registered as members in the electronic commerce means of the electronic commerce management computer 100, and buyer information who purchased products as non-members, and a product information content storage 220 that stores and manages product information content including product ratings and reviews in connection with the registered participant information; at least one user terminal 300 in communication with the electronic commerce management computer 100 and used by a user who is registered as a buyer member of the electronic commerce means or a non-member to purchase products; and at least one producer terminal 400 in communication with the electronic commerce management computer 100 and used by a producer who is registered as a producer member of the electronic commerce means and provides products production information and related person information; at least one seller terminal 500 communicatively connected to the electronic commerce management computer 100 and used by a seller who directly manages the electronic commerce means or is registered as a seller member to register products and provide related person information; a social network information medium 600 to which the electronic commerce management computer 100 can access and collect relationship data indicating a specific relationship between people based on the information of the producer and the seller; and a content registration external medium 700 that exposes the product information managed by the electronic commerce management computer 100 upon registration.

The electronic commerce management computer 100 may comprise at least one server computer having communication means and capable of operating and managing electronic commerce means such as an Internet shopping mall, executing computer programs or web programs, etc. The electronic commerce management computer 100 is configured to include at least one hardware processor and a memory in which a web program or a computer program implementing an embodiment of the present invention is stored. The at least one hardware processor is configured to control the web program or computer program stored in the memory to implement an embodiment of the present invention.

The data storage computer 200 may be configured as a database management system (DBMS) for managing updates of data such as content being stored.

The user terminal 300, producer terminal 400, and seller terminal 500 may comprise terminals such as smartphones, tablet computers, personal computers (PCs), laptops, and the like that are equipped with communication means and on which applications or web programs can be executed.

The social network information medium 600 and the content registration external medium 700 may comprise various social networking services (SNS) and internet media such as blogs, websites, etc.

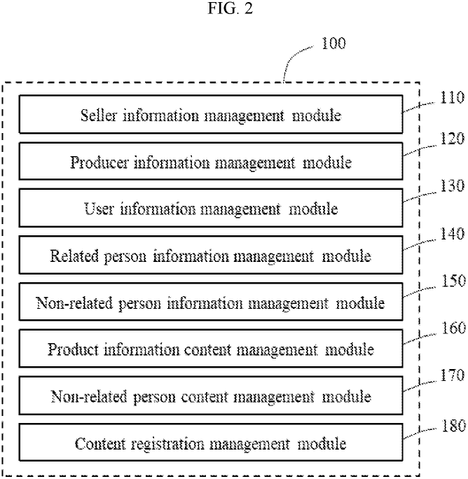

FIG. 2 is a schematic configuration of an embodiment of an electronic commerce management computer, which is the main part of the product information provision system of the present invention.

The embodiment of the electronic commerce management computer 100 in FIG. 2 may be a component of a web program or a computer program executed by utilizing the hardware resources of the electronic commerce management computer 100. Hereinafter, the electronic commerce management computer 100 will be described as a component of a web program or computer program that is executed.

As illustrated in FIG. 2, the electronic commerce management computer 100 of the present invention includes a seller information management module 110 that stores and manages information of a seller who sells products by registering products in an electronic commerce means such as an independent (standalone) online shopping mall or an open market (marketplace) online shopping mall; a producer information management module 120 that stores and manages information of a producer who provides products produced to a seller who sells products by registering products in an electronic commerce means such as an independent (standalone) online shopping mall or an open market (marketplace) online shopping mall; a user information management module 130 that stores and manages information of a buyer who purchases products in an electronic commerce means such as an independent (standalone) online shopping mall or an open market (marketplace) online shopping mall; a related person information management module 140 that stores and manages information of related persons, including acquaintances or competitors of the sellers and producers, and acquaintances of the users; a non-related person information management module 150 that excludes the information of the related persons of the seller, producer, and user related to the product transaction from the participant information including the stored member information or the applicant information providing the review of the product use, and then sets them as non-related person related to the transaction product by a prescribed method or an artificial intelligence (AI) program; a product information content management module 160 that receives various product information-related contents including product ratings or product reviews related to the transaction product entered by the participant including the user, and stores and manages them in connection with the content provider information; a non-related person content management module 170 that extracts product information contents of participants who are non-related persons among participants who have entered content from the information of participants who have entered product information contents related to trading products managed by the product information content management module 160 and non-related information managed by the non-related information management module 150, and stores and manages the product information contents as non-related person contents; and a content registration management module 180 that registers and manages the product information content of the non-related person managed by the non-related person content management module 170 to the electronic commerce means or various content registration external media.

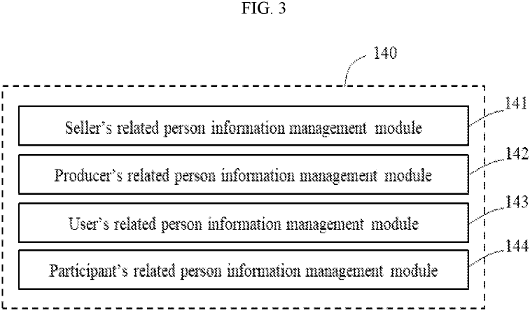

FIG. 3 is a schematic block diagram of an embodiment of the relationship information management module of the electronic commerce management computer of the present invention.

As illustrated in FIG. 3, the related person information management module 140 of the present invention includes a seller relate person information management module 141 that manages information of a seller, including a seller of a product traded in the electronic commerce means, a seller’s acquaintances, family members, relatives, employees, employees of a trading company, employees of a competitor, a producer of a product supply, and the like; a producer related person information management module 142 that manages the related person information of a producer of the products, including a producer of a product transacted in the electronic commerce means, a producer’s acquaintances, family members, relatives, employees, employees of a trading company, employees of a competitor, a seller of a product, etc.; a user related person information management module 143 that manages the related person information of the buyer of the products, including the buyer of the product, the buyer’s acquaintances, family members, relatives, employees, employees of a trading company, employees of a competitor, and the like; and a participant related person information management module 144 that manages the related person information of the participants of the products, excluding overlapping related persons among the related persons of the seller, producer, and user.

The extraction of the related person information of the seller, producer, and user analyzes the communication details of the seller, producer, and user provided, extracts words, expressions, vocabulary, etc. indicating a specific relationship between people from the communication with the acquaintances included in the communication details as relationship data, and determines the consistency with the relationship data indicating a specific relationship between people stored in the system and collected and updated from the social network information media, and selects the acquaintances whose consistency is recognized in accordance with the set rules as related persons, and as for the employees of competitors, the information is provided by the seller, producer, and user and can be included as related persons.

In addition, the electronic commerce management computer 100 may classify products by receiving information on products produced, supplied, and distributed by sellers, producers, etc. in advance and designate sellers and producers who produce, supply, and distribute the same or similar products as competitors, and may automatically classify sellers and producers who deal with the same or similar products as competitors by using an artificial intelligence program to obtain relevant information from its own database or social network information media and automatically update additional information.

On the other hand, users who are buyers of transaction products can also be included as related parties. Users can be uniformly included as participant relatives, and content such as product ratings and testimonials of users can be monitored to determine whether to include them as participant relatives. In particular, if a user has a certain quid pro quo relationship or interest with a seller and its related parties, a producer and its related parties, or a competitor of a seller or producer and its related parties, the user may be required to be included as a related person. For example, there may be cases where users such as SNS influencers or famous bloggers provide favorable advertising promotion for a specific company in exchange for a certain amount of money, such as a commission, from a seller or the like. In addition, in the case of leaving a review after ordering food on a delivery app, a seller may provide a service such as a free drink or dessert to the user in exchange for a good review, thereby inducing artificial reviews from users. As a result, these users are directly or indirectly advertising and promoting the seller or producer, so they can be considered related parties of the seller or producer. Therefore, there may be “biased users” who have an interest in a particular product, such as a seller and its related persons, a producer and its related persons, a competitor of a seller or producer and its related persons, and “unbiased users” who have no interest in a particular product, such as a seller and its related persons, a producer and its related persons, a competitor of a seller or producer and its related persons. In the present invention, the biased user is considered as a participant-related person, and the unbiased user is described as a non-related person.

In an embodiment of the product information provision system of the present invention disclosed in FIGS. 1 to 3, the electronic commerce management computer 100 receives the communication details of the seller or the communication details of the producer based on the seller’s membership information for selling products registered as a member of the operated electronic commerce means and the producer’s membership information for selling products, and analyzes the communication details to obtain, store, and manage related person information including acquaintances and competitors of the seller and the producer in advance. However, without limitation, the system may be configured to obtain and manage the related person information of the seller, producer, and user when a product transaction occurs based on the user’s membership information as a buyer of the product, or when content such as product ratings and user reviews regarding the transaction product occurs.

In this case, the establishment of the related person information of the seller, producer, and user is identified by assigning unique identification information to the transaction subjects including the seller, producer, and user, and the communication counterperson of the seller, producer, and user is identified as a related person by extracting relationship data indicating a specific relationship between the seller, producer, and user in the communication details of the seller, producer, and user by analyzing the communication details and determining the consistency of the relationship data with the relationship data collected by the social network information medium 600 and updated by the social network information medium 600, and using the relationship data indicating a consistency a set value. In addition, the information of competitors or competitors related to production and transactions of the sellers, producers, and users can be collected and identified as related persons of the sellers, producers, and users.

From the participant information including various product-related sellers, producers, and users registered as members or non-members in the electronic commerce means, non-relative information can be established by identifying participants who are not related to the above-described related persons (herein, sellers and producers of certain products are also included in the related persons) as non-related person related to the described product transactions.

As an example of an embodiment of the product information provision system of the present invention, for a specific product transaction in an online shopping mall, which is an electronic commerce means managed by the electronic commerce management computer 100, the at least one user terminal 300 communicatively accesses the website or app of the online shopping mall and purchases a product through membership or as a non-member, and then registers the product information content including an evaluation or a testimonial about the purchased product in the online shopping mall. The electronic commerce management computer 100 receives and stores the product information content input from the at least one user terminal 300, and may keep the product information content pending registration in the online shopping mall, which is an electronic commerce means, to reserve external exposure.

The electronic commerce management computer 100 stores and manages participant information consisting of user members who are sellers, producers, and buyers registered for trading various products of sellers or producers who have registered to sell products in electronic commerce means such as an online shopping mall in the participant information storage 210 of the data storage computer 200.

When, as described above, the electronic commerce management computer (100) generates and manages in advance the information of sellers and producers of products to be registered and transacted in the electronic commerce means, the information of related persons of the sellers and producers, and the information of competitors of the sellers and producers, The electronic commerce management computer 100 extracts relationship data by analyzing the communication details of a user who has registered product information content, including product ratings or testimonials, for a particular product, and excludes the related person information generated by determining the product with the relationship data stored by itself (here, user information that is a person to the product transaction may also be included as a related person) and the related person information related to the seller and producer from the participant information, thereby obtaining non-related person information related to the product and the product transaction.

In this regard, as an example, when a consumer A purchases a product of a company K, a person with whom the consumer A has a direct relationship (acquaintances within the first degree), such as a business partner of the company K and an employee of the business partner, an employee of the company K, a family member or friend of the employee, a similar or homogeneous company competing with the company K, an employee of the similar or homogeneous company, and an acquaintance within the first degree of the employee may be considered as a related person and excluded from the evaluation subject of the product.

Among the registrant information of product information contents such as ratings or reviews of products inputted and managed by the at least one user terminal, the product information contents matching the related person information are filtered and excluded, and only the product information contents registered by the non-related person are registered and exposed in the electronic commerce means, and the product information contents of the non-related person are registered and exposed in the content registration external media 700.

Since the embodiment of the product information provision system by non-related persons of the present invention can select and expose to the outside only product information contents including product reviews or testimonials registered by non-related persons, the objectivity and reliability of product reviews or testimonials delivered to consumers about the product are guaranteed, which can provide useful information for consumers to make purchase decisions about the product, and the credibility of the seller or producer of the product is improved, which can lead to an increase in sales of the product.

The above describes an embodiment of registering product information contents such as product ratings or testimonials for a specific product to an electronic commerce means and an external medium other than an electronic commerce means and content registration by filtering out only product information contents registered by non-related persons other than biased user who are sellers, producers, and buyers (buyers who have a relationship with related persons in a product or product transaction) and their related persons, but is not limited to them.

In another embodiment of the product information provision system of the present invention, the product information provision system provides the registered product information content and the registered participant information to non-related person related to the product or the product transaction without determining whether the participant who registers the product information content regarding the product rating or the user review of a particular product is a related person or a non-related person related to the product or the product transaction, obtaining evaluation information of the non-related person regarding the objectivity and authenticity of the product information content, and registering only the product information content that has obtained an evaluation the threshold by the set rules to the electronic commerce means and the external medium for content registration to be exposed to the outside world.

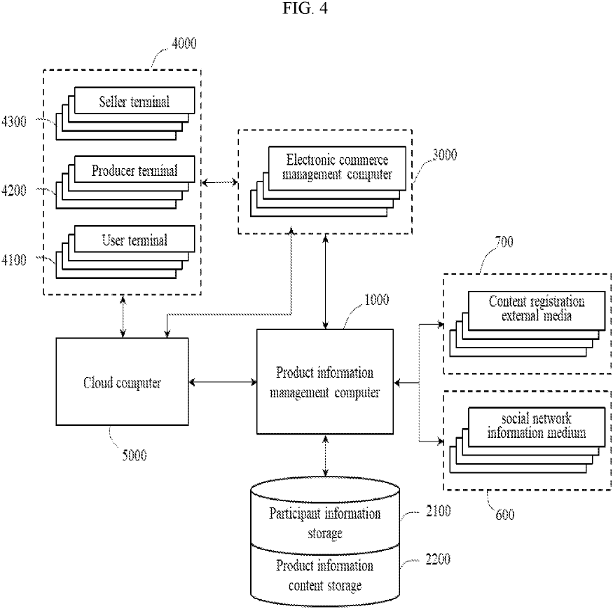

FIG. 4 is a schematic configuration of another embodiment of the product information provision system of the present invention.

As illustrated in FIG. 4, the embodiment of FIG. 1 differs from the embodiment of FIG. 1 described above in that the embodiment of the present invention is implemented on the electronic commerce management computer operating the electronic commerce means itself, and the embodiment of FIG. 4 is implemented by managing multiple electronic commerce management computers each operating the electronic commerce means by an independent product information management computer. In the description of the invention configuration of the embodiment of FIG. 4, the same components described in the embodiment of FIG. 1 will also be described with different designations for efficiency of description and understanding.

As illustrated in FIG. 4, the product information provision system of the present invention comprises a product information management computer 1000 that is in communication with at least one electronic commerce management computer that operates electronic commerce means to trade products, and manages product information including information of a seller of a product and a related person, information of a producer of a product and a related person, information of a competitor of the seller and producer and a related person, information of a user who is a buyer and a related person, and reviews of products registered or to be registered by participants and reviews of product use; a data storage computer 2000 that includes a participant information storage book 2100 that stores and manages participant information including user information, seller information, and producer information registered as members in the electronic commerce means of the at least one electronic commerce management computer, and buyer information that purchases products as a non-member and a product information content storage book 2200 that stores and manages product information content including product ratings and reviews in connection with the participant information registered; at least one electronic commerce management computer 3000 that operates an electronic commerce means such as an individual (standalone) online shopping mall or an open market (marketplace) online shopping mall and receives and manages participant information including user information and seller information as a product buyer and provides it to the product information management computer 1000, and has means for registering and exposing content such as product ratings and user reviews of transaction products provided by the product information management computer 1000; participant terminal 4000 including at least one user terminal 4100 in communication with the at least one electronic commerce management computer 3000, each equipped with an online electronic commerce means, and used by a user who is registered as a purchaser member of the electronic commerce means or who performs a purchase of products as a non-member, at least one producer terminal 4200 in communication with the electronic commerce management computer 3000 and used by producers who are registered as producer members in the electronic commerce means and provide product production information and related person information, and at least one seller terminal 4300 in communication with the electronic commerce management computer 3000 and used by sellers who directly manage the electronic commerce means or are registered as seller members and provide product registration and related person information; a cloud computer 5000 communicatively connected to the product information management computer 1000, the at least one electronic commerce management computer 3000, and the participant terminal 4000, respectively, and capable of providing virtual storage space to users of the product information management computer 1000, the at least one electronic commerce management computer 3000, and the participant terminal 4000, and of executing cloud programs with the same structure as programs executed on the product information management computer 1000 on its own; a social network information medium 6000 that enables the product information management computer 1000 to access and collect relationship data representing specific relationships between people based on the information of producers and sellers; and a content registration external medium 7000 that exposes the product information managed by the product information management computer 1000 when it is registered.

The product information management computer 1000 includes at least one hardware processor and a memory storing a web program or computer program executing an embodiment of the present invention.

The present invention is configured so that the at least one hardware processor controls a web program or computer program stored in the memory to implement the operation of the embodiment of the present invention.

The data storage computer 2000 may be configured as a database management system (DBMS) for managing updates of data such as content being stored.

The user terminal 4100, the producer terminal 4200, and the seller terminal 4300 may comprise a terminal such as a smartphone, a tablet computer, a personal computer (PC), a laptop, or the like that is equipped with a communication means and on which an application or a web program can be executed.

The cloud computer 5000 may comprise a computer operating a known cloud system.

The social network information medium 6000 and the content registration external medium 7000 may comprise various social network services (SNS) and internet media such as blogs, websites, etc.

Each executable component of the web program or computer program loaded into the memory controlled by the at least one hardware processor of the product information management computer 1000 is not different from the configurations of FIGS. 2 and 3 above, so the description will be omitted here.

In the above-described embodiments of FIGS. 1 to 3, the electronic commerce management computer 100 constructs related person and non-related person information related to product or product transaction, selects product information contents by non-related person, and non-related person of registered product information contents, evaluation, and registration of product information contents in electronic commerce means and contents registration external media. However, in the embodiment of the product information providing system of the present invention shown in FIG. 4, the product information management computer 1000 and at least one electronic commerce management computer 3000 perform these functions integrally.

Furthermore, in the embodiment of the present invention shown in FIG. 4, the cloud computer 5000 provides a virtual storage space for participants including sellers, producers, and users and non-related persons, so that the participant information stored in the virtual storage space can be taken and utilized by the at least one electronic commerce management computer 3000 and the product information management computer 1000, and various information generated by the at least one electronic commerce management computer 3000 and the product information management computer 1000 can be stored in the virtual storage space of the participants, so that the participants can utilize it.

The operation of the product information provision system of the present invention illustrated in FIGS. 1 and 4 is not limited to the above description. In the description of each component in the implementation of the product information provision method of the present invention described below, specific examples of the operation description will be described in more detail.

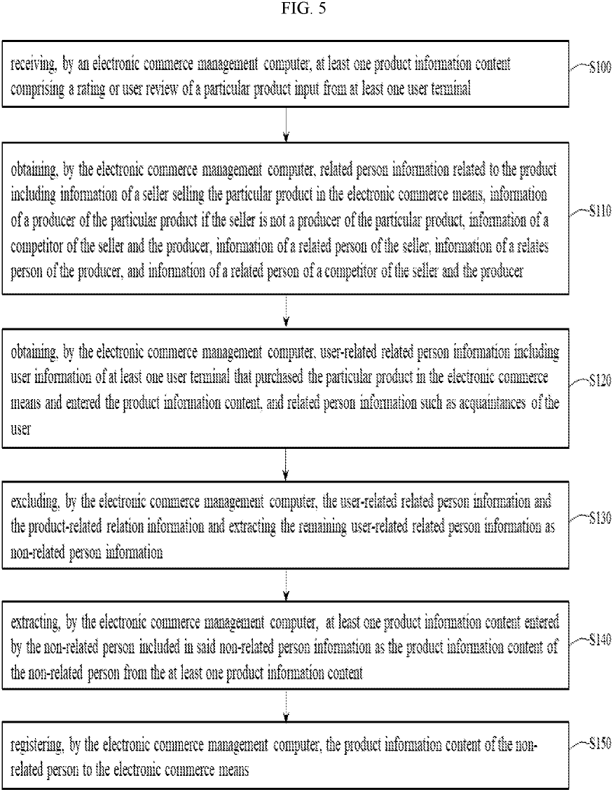

FIG. 5 is a flow diagram to illustrate an embodiment of the product information provision method of the present invention.

As illustrated in FIG. 5, the product information provision method of the present invention includes receiving, by an electronic commerce management computer, at least one product information content comprising a rating or user review of a particular product input from at least one user terminal (S100); obtaining, by the electronic commerce management computer, related person information related to the product including information of a seller selling the particular product in the electronic commerce means, information of a producer of the particular product if the seller is not a producer of the particular product, information of a competitor of the seller and the producer, information of a related person of the seller, information of a relates person of the producer, and information of a related person of a competitor of the seller and the producer (S110); obtaining, by the electronic commerce management computer, user-related related person information including user information of at least one user terminal that purchased the particular product in the electronic commerce means and entered the product information content, and related person information such as acquaintances of the user (S120); excluding, by the electronic commerce management computer, the user-related related person information and the product-related relation information and extracting the remaining user-related related person information as non-related person information (S130); extracting, by the electronic commerce management computer, at least one product information content entered by the non-related person included in said non-related person information as the product information content of the non-related person from the at least one product information content (140); and registering, by the electronic commerce management computer, the product information content of the non-related person to the electronic commerce means (S150).

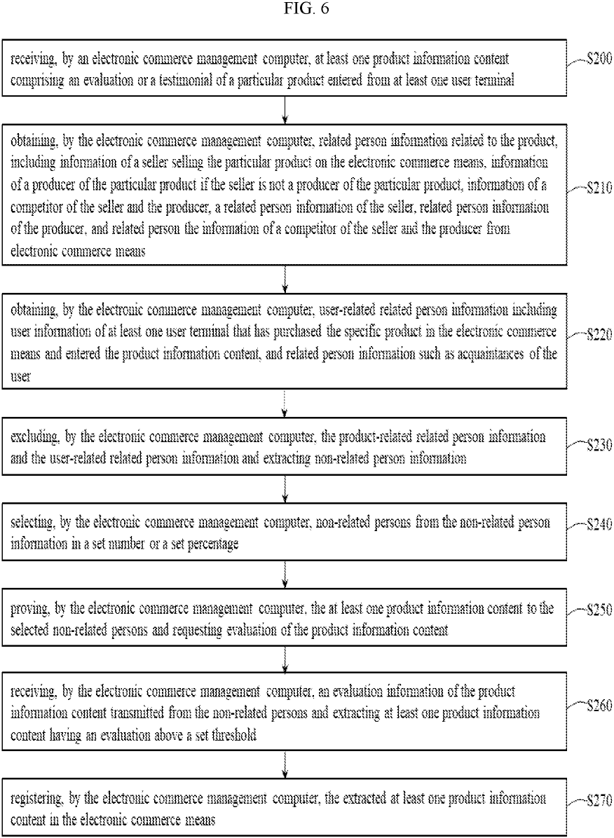

FIG. 6 is a flow diagram to illustrate another embodiment of the product information provision method of the present invention.

As illustrated in FIG. 6, a product information provision method of the present invention, comprising: receiving, by an electronic commerce management computer, at least one product information content comprising an evaluation or a testimonial of a particular product entered from at least one user terminal (S200); obtaining, by the electronic commerce management computer, related person information related to the product, including information of a seller selling the particular product on the electronic commerce means, information of a producer of the particular product if the seller is not a producer of the particular product, information of a competitor of the seller and the producer, a related person information of the seller, related person information of the producer, and related person the information of a competitor of the seller and the producer from electronic commerce means (S210); obtaining, by the electronic commerce management computer, user-related related person information including user information of at least one user terminal that has purchased the specific product in the electronic commerce means and entered the product information content, and related person information such as acquaintances of the user (S220); excluding, by the electronic commerce management computer, the product-related related person information and the user-related related person information and extracting non-related person information (S230); selecting, by the electronic commerce management computer, non-related persons from the non-related person information in a set number or a set percentage (S240); proving, by the electronic commerce management computer, the at least one product information content to the selected non-related persons and requesting evaluation of the product information content (S250); receiving, by the electronic commerce management computer, an evaluation information of the product information content transmitted from the non-related persons and extracting at least one product information content having an evaluation above a set threshold (S260); and registering, by the electronic commerce management computer, the extracted at least one product information content in the electronic commerce means (S270).

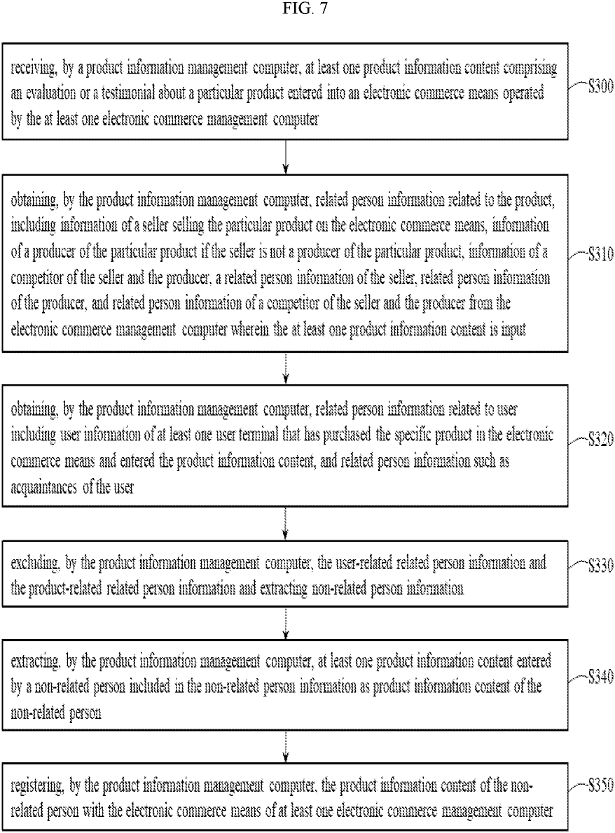

FIG. 7 is a flow diagram to illustrate another embodiment of the product information provision method of the present invention.

As illustrated in FIG. 7, the product information provision method of the present invention comprising: receiving, by a product information management computer, at least one product information content comprising an evaluation or a testimonial about a particular product entered into an electronic commerce means operated by the at least one electronic commerce management computer (S300); obtaining, by the product information management computer, related person information related to the product, including information of a seller selling the particular product on the electronic commerce means, information of a producer of the particular product if the seller is not a producer of the particular product, information of a competitor of the seller and the producer, a related person information of the seller, related person information of the producer, and related person information of a competitor of the seller and the producer from the electronic commerce management computer wherein the at least one product information content is input (S310); obtaining, by the product information management computer, related person information related to user including user information of at least one user terminal that has purchased the specific product in the electronic commerce means and entered the product information content, and related person information such as acquaintances of the user (S320); excluding, by the product information management computer, the user-related related person information and the product-related related person information and extracting non-related person information (S330); extracting, by the product information management computer, at least one product information content entered by a non-related person included in the non-related person information as product information content of the non-related person (S340); and registering, by the product information management computer, the product information content of the non-related person with the electronic commerce means of at least one electronic commerce management computer (S350).

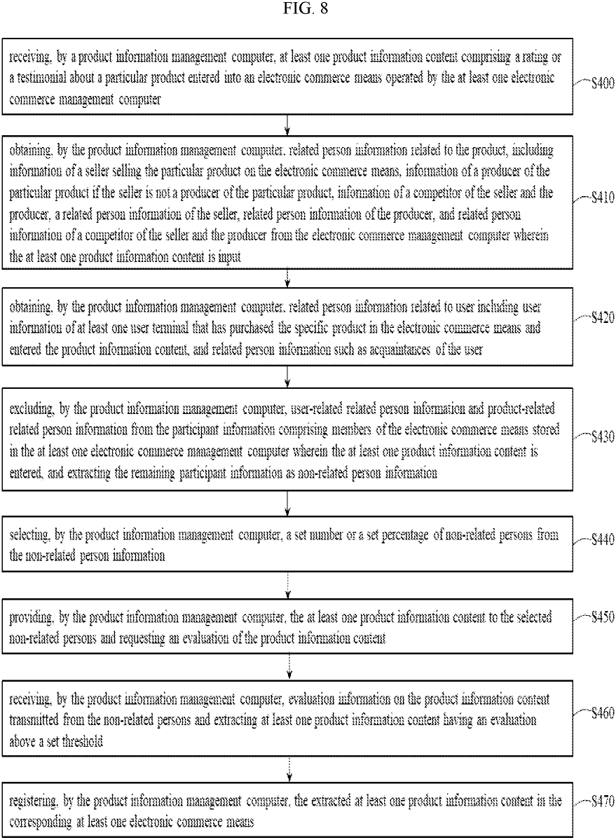

FIG. 8 is a flow diagram to illustrate another embodiment of the product information provision method of the present invention.

As illustrated in FIG. 8, the product information provision method of the present invention comprising: receiving, by a product information management computer, at least one product information content comprising a rating or a testimonial about a particular product entered into an electronic commerce means operated by the at least one electronic commerce management computer (S400); obtaining, by the product information management computer, related person information related to the product, including information of a seller selling the particular product on the electronic commerce means, information of a producer of the particular product if the seller is not a producer of the particular product, information of a competitor of the seller and the producer, a related person information of the seller, related person information of the producer, and related person information of a competitor of the seller and the producer from the electronic commerce management computer wherein the at least one product information content is input (S410); obtaining, by the product information management computer, related person information related to user including user information of at least one user terminal that has purchased the specific product in the electronic commerce means and entered the product information content, and related person information such as acquaintances of the user (S420); excluding, by the product information management computer, user-related related person information and product-related related person information from the participant information comprising members of the electronic commerce means stored in the at least one electronic commerce management computer wherein the at least one product information content is entered, and extracting the remaining participant information as non-related person information (S430); selecting, by the product information management computer, a set number or a set percentage of non-related persons from the non-related person information (S440); providing, by the product information management computer, the at least one product information content to the selected non-related persons and requesting an evaluation of the product information content (S450); receiving, by the product information management computer, evaluation information on the product information content transmitted from the non-related persons and extracting at least one product information content having an evaluation above a set threshold (S460); and registering, by the product information management computer, the extracted at least one product information content in the corresponding at least one electronic commerce means (S470).

The embodiments of the product information provision system and the product information provision method of the present invention described above are only some of the various embodiments of the present invention.

In the registration of product information contents including ratings or testimonials related to a particular product or product transaction in an electronic commerce system such as the online shopping mall of the present invention, it is natural that the various embodiments included in the technical idea of registering only product information contents generated by non-related persons other than the seller of the product and the seller’s related persons, the producer of the product and the producer’s related persons, the competitor of the seller and the producer and the competitor’s related persons, or the user who is a buyer of the product and the user’s related persons, in the electronic commerce means are included in the scope of protection of the present invention.

The present invention can be used in the industry of providing quality product information to consumers in an online electronic commerce system.

What is claimed is:

1. An electronic commerce management computer comprising:
electronic commerce means, at least one hardware processor, and a memory storing a program,
wherein the at least one hardware processor controls the execution of the program stored in the memory to:
receive product information content relating to a product generated by participants;
extract information of a non-related person who is not related to the product from the participants; and
register the product information content entered by the non-related person to the electronic commerce means.

2. An electronic commerce management computer comprising:
electronic commerce means, at least one hardware processor, and a memory storing a program,
wherein the at least one hardware processor controls the execution of the program stored in the memory to:
receive product information content relating to a product generated by participants;
extract information of a non-related person who is not related to the product from the participants;
provide the product information content to the non-related person and requesting an evaluation of the product information content; and
register the product information content conforming to the criteria set based on the evaluation information of the product information content provided by the non-related person, to the electronic commerce means.

3. The electronic commerce management computer of claim 1, wherein the product information content includes ratings or testimonials related to products and product transactions.

4. The electronic commerce management computer of claim 1, wherein the extraction of the information of the non-related person is performed by analyzing the communication details between the participants who entered the product information content and excluding the related persons related to the product.

5. The electronic commerce management computer of claim 4, wherein the product-related related persons are selected by analyzing the communication details of the seller of the product, the producer of the product when the seller is not the producer, and the competitor of the seller and the producer to extract relationship data indicating a specific relationship between the persons.

6. A product information management computer in communication with at least one electronic commerce management computer managing electronic commerce means, comprising:
at least one hardware processor and a memory storing a program,
wherein the at least one hardware processor controls execution of the program stored in the memory to:
receive product information content concerning products generated by participants and registered in a particular electronic commerce means;
extract information of non-related person who is not related to the product among the participants; and
register the product information content entered by the non-related person to the particular electronic commerce means.

7. A product information management computer in communication with at least one electronic commerce management computer managing electronic commerce means, comprising:
at least one hardware processor and a memory storing a program,
wherein the at least one hardware processor controls execution of the program stored in the memory to:
receive product information content concerning products generated by participants and registered in a particular electronic commerce means;
extract information of non-related person who is not related to the product among the participants;
provide the product information content to the non-related person and requesting an evaluation of the product information content; and
register the product information content conforming to the criteria set based on the evaluation information of the product information content provided by the non-related person, to the electronic commerce means.

8. The product information management computer of claim 6, wherein the product information content includes ratings or testimonials related to products and product transactions.

9. The product information management computer of claim 6, wherein the extraction of the information of the non-related person is performed by analyzing the communication details between the participants who entered the product information content and excluding the related persons related to the product.

10. The product information management computer of claim 9, wherein the product-related related persons are selected by analyzing the communication details of the seller of the product, the producer of the product when the seller is not the producer, and the competitor of the seller and the producer to extract relationship data indicating a specific relationship between the persons.

11. A product information provision method using an electronic commerce management computer that manages electronic commerce means, comprising:
receiving, by the electronic commerce management computer, product information content relating to a product generated by participants;
extracting, by the electronic commerce management computer, information of a non-related person who is not related to the product from the participants; and
registering, by the electronic commerce management computer, the product information content entered by the non-related person to the electronic commerce means.

12. A product information provision method using an electronic commerce management computer that manages electronic commerce means, comprising:
receiving, by the electronic commerce management computer, product information content relating to a product generated by participants;
extracting, by the electronic commerce management computer, information of a non-related person who is not related to the product from the participants;
providing, by the electronic commerce management computer, the product information content to the non-related person and requesting an evaluation of the product information content; and
registering, by the electronic commerce management computer, the product information content conforming to the criteria set based on the evaluation information of the product information content provided by the non-related person, to the electronic commerce means.

13. A product information provision method using a product information management computer in communication with at least one electronic commerce management computer managing the electronic commerce means, comprising:
receiving, by the product information management computer, product information content relating to a product registered in a particular electronic commerce means generated by participants;
extracting, by the product information management computer, information of a non-related person who is not related to the product from the participants; and
registering, by the product information management computer, the product information content entered by the non-related person to the electronic commerce means.

14. A product information provision method using a product information management computer in communication with at least one electronic commerce management computer managing the electronic commerce means, comprising:
receiving, by the product information management computer, product information content relating to a product registered in a particular electronic commerce means generated by participants;
extracting, by the product information management computer, information of a non-related person who is not related to the product from the participants;
providing, by the product information management computer, the product information content to the non-related person and requesting an evaluation of the product information content; and
registering, by the product information management computer, the product information content conforming to the criteria set based on the evaluation information of the product information content provided by the non-related person, to the electronic commerce means.

15. The product information provision method of claim 11, wherein the extraction of the information of the non-related person is performed by analyzing the communication details between the participants who entered the product information content and excluding the related persons of the product.
